(19) United States
(12) Patent Application Publication
(10) Pub. No.: US 2022/0072691 A1
(43) Pub. Date: Mar. 10, 2022

(54) FASTENER DRIVING TOOL

(71) Applicant: Hilti Aktiengesellschaft, Schaan (LI)

(72) Inventors: Dominik SCHMIDT, Frastanz (AT); Ajinkya Hemant DANGE, Eschen (LI)

(21) Appl. No.: 17/416,448

(22) PCT Filed: Nov. 29, 2019
(86) PCT No.: PCT/EP2019/083017

§ 371 Date: Jun. 18, 2021

(30) Foreign Application Priority Data
Dec. 20, 2018 (EP) 18214865.0

(51) Int. Cl. B25C 1/04; B25C 1/06

(52) U.S. Cl. CPC B25C 1/047; B25C 1/06

(57) ABSTRACT

A setting device for driving fastening elements in a setting direction into a substrate is provided, having a driving-in element movable between a starting position and a setting position, a drive driving the driving-in element in the setting direction from the starting position to the setting position transferring energy to a fastening element, and a resetting device conveying the driving-in element counter to the setting direction from the setting position to the starting position, the resetting device comprising a rotor, rotatable about an axis of rotation, and a driver element on the rotor which can be engaged with the driving-in element, driving the driving-in element counter to the setting direction, the driver element being mounted on the rotor radially movable wherein, upon rotor rotation, the driver element moves from the axis of rotation to engage with the driving-in element.

### TECHNICAL FIELD

The invention relates to a setting device for driving fastening elements in a setting direction into a substrate.

### PRIOR ART

Such devices customarily comprise a driving-in element which is movable back and forth between a starting position and a setting position, a drive which drives the driving-in element in the setting direction from the starting position to the setting position in order to transfer energy to a fastening element, and a resetting device which conveys back the driving-in element counter to the setting direction from the setting position to the starting position.

It is an object of the invention to make available a device for driving a fastening element into a substrate in which such resetting of the driving-in element is improved.

### SUMMARY OF THE INVENTION

The object is achieved with a setting device for driving fastening elements in a setting direction into a substrate, having a driving-in element which is movable back and forth between a starting position and a setting position, having a drive which is provided for driving the driving-in element in the setting direction from the starting position to the setting position in order to transfer energy to a fastening element, and having a resetting device which is provided for conveying the driving-in element counter to the setting direction from the setting position to the starting position, wherein the resetting device comprises a rotor, which can rotate about an axis of rotation, and a driver element which is mounted on the rotor and which can be brought into engagement with the driving-in element in order to drive along the driving-in element counter to the setting direction, wherein the driver element is mounted on the rotor so as to be radially movable with respect to the axis of rotation, with the result that, upon rotation of the rotor, the driver element moves away from the axis of rotation in order to come into engagement with the driving-in element. Consequently, the driver element comes automatically into engagement with the driving-in element, with the result that the resetting of the driving-in element is simplified.

One advantageous embodiment is characterized in that the resetting device comprises a spring which acts between the rotor and the driver element and loads the driver element toward the axis of rotation. As a result, the driver element and the driving-in element also come automatically out of engagement again as soon as the rotation of the rotor is ended.

One advantageous embodiment is characterized in that the driving-in element has one or more depressions in which the driver element engages if the driver element is in engagement with the driving-in element.

One advantageous embodiment is characterized in that the resetting device comprises a plurality of driver elements mounted on the rotor. The driver elements preferably have equal spacings from one another in the circumferential direction with respect to the axis of rotation.

One advantageous embodiment is characterized in that the drive is provided for setting the rotor in rotation. The drive preferably comprises a flywheel which is provided for driving the driving-in element in the driving-in direction and for setting the rotor in rotation in order to convey the driving-in element counter to the driving-in direction. The drive also preferably comprises a motor which is provided for setting the rotor in rotation in order to convey the driving-in element counter to the driving-in direction.

One likewise advantageous embodiment is characterized in that the resetting device comprises a motor which is separate from the drive and which is provided for setting the rotor in rotation in order to convey the driving-in element counter to the driving-in direction.

Further advantages, features and details of the invention will emerge from the following description in which different exemplary embodiments are described in detail with reference to the drawing, in which:

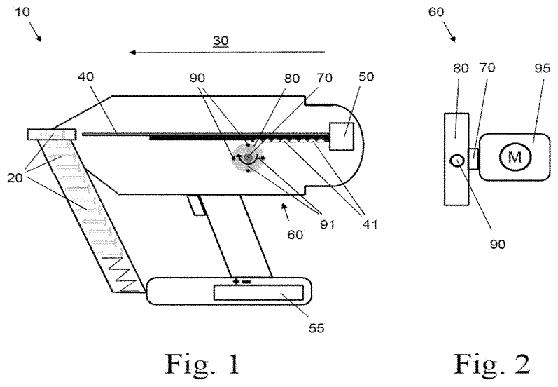

FIG. 1 schematically shows a setting device,

FIG. 2 shows a resetting device,

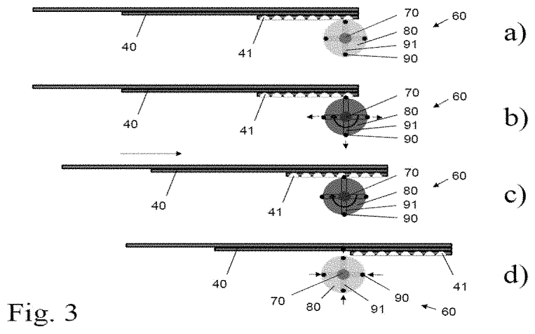

FIG. 3 shows a driving-in element and a resetting device during a resetting operation, and

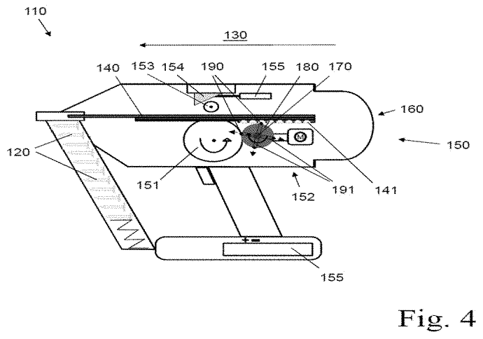

FIG. 4 schematically shows a setting device.

### EXEMPLARY EMBODIMENTS

FIG. 1 schematically illustrates a setting device 10 for driving fastening elements 20 in a setting direction 30 into a substrate. The setting device 10 comprises a driving-in element 40 which preferably takes the form of a setting plunger and which is movable back and forth between a starting position and a setting position. Furthermore, the setting device 10 comprises a drive 50 which is provided for driving the driving-in element 40 in the setting direction 30 from the starting position illustrated in FIG. 1 to the setting position in order to transfer energy to a fastening element 20. The drive 50 comprises an energy store, for example a potential energy store such as a mechanical or pneumatic spring or an electrical energy store such as a capacitor, and an energy transfer device which is provided for transferring energy from an electrical energy source 55, for example an electric battery, to the energy store. The drive 50 is provided for suddenly discharging the energy store in order to transfer the energy stored therein to the driving-in element 40.

The setting device 10 comprises a resetting device 60 which is provided for conveying the driving-in element 10 counter to the setting direction 30 from the setting position to the starting position. The resetting device 60 comprises a rotor 80, which can rotate about an axis of rotation 70, and four driver elements 90 which are mounted on the rotor 80 and which have equal spacings from one another in the circumferential direction with respect to the axis of rotation 70. The driving-in element 40 has a plurality of depressions 41 which are arranged opposite the driver elements 90 in such a way that the driver elements 90 can be brought into engagement with the depressions 41 in order to drive along the driving-in element 40 counter to the setting direction 30. For this purpose, the driver elements 90 are mounted on the rotor 80 so as to be radially movable with respect to the axis of rotation 70, with the result that, upon rotation of the rotor 80, the driver elements 90 move radially outwardly away from the axis of rotation 70 in order to come into engagement with the depressions 41 of the driving-in element 40. This occurs, for example, on account of the centrifugal force which occurs during the rotation. In exemplary embodiments which are not shown, the driver elements each have an air-deflecting surface which is inclined with respect to a circumferential direction of the rotor and which deflects the air toward the axis of rotation in order to accelerate the respective driver element away from the axis of rotation. The resetting device 60 comprises four springs 91 which act between the rotor 80 and in each case a driver element 90 in order to load the respective driver element 90 toward the axis of rotation 70. As a result, the driver elements 90 and the driving-in element 40 are out of engagement when the rotor does not rotate. The resetting device 60 comprises a motor which is separate from the drive 50. In FIG. 1, the motor is concealed by the rotor 80 and is provided for setting the rotor 80 in rotation in the clockwise direction in order to convey the driving-in element 40 counter to the driving-in direction 30.

In FIG. 2, the resetting device 60 is illustrated in a view in the driving-in direction. The resetting device 60 comprises the axis of rotation 70, the rotor 80 in the form of a disk, the driver elements 90 and the motor 95.

FIG. 3 illustrates the driving-in element 40 with the resetting device 60 in a number of phases of a resetting operation. First of all, the driving-in element is situated in the setting position, the rotor 80 not rotating (FIG. 3a). For resetting purposes, the rotor 80 is set in rotation about the axis of rotation 70, with the result that the driver elements 90 successively engage in the depressions 41 of the driving-in element (FIG. 3b). As a result, the driving-in element 40 is moved counter to the driving-in direction (to the right in FIG. 3) (FIG. 3c). As soon as the driving-in element 40 has reached its starting position, the rotation of the rotor 80 is ended, with the result that the driver elements 90 come out of engagement with the depressions 41 (FIG. 3d).

FIG. 4 schematically illustrates a further setting device 110 for driving fastening elements 120 in a setting direction 130 into a substrate. The setting device 110 comprises a driving-in element 140 which is movable back and forth between a starting position and a setting position. Furthermore, the setting device 110 comprises a drive 150 which is provided for driving the driving-in element 140 in the setting direction 130 from the starting position to the setting position in order to transfer energy to a fastening element 120. The drive 150 comprises a flywheel 151 and an energy transfer device 152 which is provided for transferring energy from an electrical energy source 155, for example an electric battery, to the flywheel 151. The drive 50 is provided for pressing the driving-in element 140 onto the flywheel 151 by means of a counter-roller 153 in order to transfer the energy stored in the flywheel 151 to the driving-in element 140. This occurs with a wedge 154 which is moved toward the counter-roller by means of a, for example electromagnetic, actuating element 155.

The setting device 110 comprises a resetting device 160 which is provided for conveying the driving-in element 110 counter to the setting direction 130 from the setting position to the starting position. The resetting device 160 comprises a rotor 180, which can rotate about an axis of rotation 170, and four driver elements 190 which are mounted on the rotor 180 and which have equal spacings from one another in the circumferential direction with respect to the axis of rotation 170. The driving-in element 140 has a plurality of depressions 141 which are arranged opposite the driver elements 190 in such a way that the driver elements 190 can be brought into engagement with the depressions 141 in order to drive along the driving-in element 140 counter to the setting direction 130. For this purpose, the driver elements 190 are mounted on the rotor 180 so as to be radially movable with respect to the axis of rotation 170, with the result that, upon rotation of the rotor 180, the driver elements 190 move radially outwardly away from the axis of rotation 170 in order to come into engagement with the depressions 141 of the driving-in element 140. The resetting device 160 comprises four springs 191 which act between the rotor 180 and in each case a driver element 190 in order to load the respective driver element 190 toward the axis of rotation 170. As a result, the driver elements 190 and the driving-in element 140 are out of engagement when the rotor does not rotate. In the present example, the drive 150 comprises the energy transfer device 152 and a motor 156 which, on the one hand, transfers energy to the flywheel 151 and, on the other hand, sets the rotor 180 in rotation in order to convey the driving-in element 140 counter to the driving-in direction.

The invention has been explained above on the basis of a number of exemplary embodiments of a driving-in device. In this respect, the features described can be transferred individually or in combination from each exemplary embodiment to all other exemplary embodiments as long as they do not contradict one another. It should be noted that the device according to the invention can also be used for other purposes.

1. A setting device for driving fastening elements in a setting direction into a substrate, having a driving-in element which is movable back and forth between a starting position and a setting position; a drive provided for driving the driving-in element in the setting direction from the starting position to the setting position to transfer energy to a fastening element; and a resetting device provided for conveying the driving-in element counter to the setting direction from the setting position to the starting position, wherein the resetting device comprises a rotor, which can rotate about an axis of rotation, and a driver element which is mounted on the rotor and which can be brought into engagement with the driving-in element to drive along the driving-in element counter to the setting direction, wherein the driver element is mounted on the rotor so as to be radially movable with respect to an axis of rotation, with the result that, upon rotation of the rotor, the driver element moves away from the axis of rotation to come into engagement with the driving-in element.

2. The setting device as claimed in claim 1, wherein the resetting device comprises a spring which acts between the rotor and the driver element and loads the driver element toward the axis of rotation.

3. The setting device as claimed in claim 1, wherein the driving-in element has one or more depressions in which the driver element engages if the driver element is in engagement with the driving-in element.

4. The setting device as claimed in claim 1, wherein the resetting device comprises a plurality of driver elements mounted on the rotor.

5. The setting device as claimed in claim 4, wherein the driver elements have equal spacings from one another in a circumferential direction with respect to the axis of rotation.

6. The setting device as claimed in claim 1, wherein the drive is provided for setting the rotor in rotation.

7. The setting device as claimed in claim 6, wherein the drive comprises a flywheel provided for driving the driving-in element in the driving-in direction and for setting the rotor in rotation to convey the driving-in element counter to the driving-in direction.

8. The setting device as claimed in claim 6, wherein the drive comprises a motor which is provided for setting the rotor in rotation to convey the driving-in element counter to the driving-in direction.

9. The setting device as claimed in claim 1, wherein the resetting device comprises a motor which is separate from the drive and which is provided for setting the rotor in rotation to convey the driving-in element counter to the driving-in direction.

10. The setting device as claimed in claim 2, wherein the driving-in element has one or more depressions in which the driver element engages if the driver element is in engagement with the driving-in element.

11. The setting device as claimed in claim 2, wherein the resetting device comprises a plurality of driver elements mounted on the rotor.

12. The setting device as claimed in claim 3, wherein the resetting device comprises a plurality of driver elements mounted on the rotor.

13. The setting device as claimed in claim 11, wherein the driver elements have equal spacings from one another in a circumferential direction with respect to the axis of rotation.

14. The setting device as claimed in claim 12, wherein the driver elements have equal spacings from one another in a circumferential direction with respect to the axis of rotation.

15. The setting device as claimed in claim 2, wherein the drive is provided for setting the rotor in rotation.

16. The setting device as claimed in claim 3, wherein the drive is provided for setting the rotor in rotation.

17. The setting device as claimed in claim 4, wherein the drive is provided for setting the rotor in rotation.

18. The setting device as claimed in claim 5, wherein the drive is provided for setting the rotor in rotation.

19. The setting device as claimed in claim 10, wherein the drive is provided for setting the rotor in rotation.

20. The setting device as claimed in claim 11, wherein the drive is provided for setting the rotor in rotation.
